(19) United States
(12) Patent Application Publication
(10) Pub. No.: US 2023/0356571 A1
(43) Pub. Date: Nov. 9, 2023

(54) APPARATUS AND METHODS FOR VARIABLE TINT GLAZING

(71) Applicant: JAGUAR LAND ROVER LIMITED, Whitley, Coventry, Warwickshire (GB)

(72) Inventors: Stephen PENTON, Whitley, Coventry, Warwickshire (GB); Georgi MIHAYLOV, Whitley, Coventry, Warwickshire (GB); Stephen THORNDALE, Whitley, Coventry, Warwickshire (GB); Craig HOUSTON, Whitley, Coventry, Warwickshire (GB)

(21) Appl. No.: 18/245,863

(22) PCT Filed: Sep. 17, 2021
(86) PCT No.: PCT/EP2021/075688

§ 371 Date: Mar. 17, 2023

(30) Foreign Application Priority Data
Sep. 18, 2020 (GB) 2014714.6

(51) Int. Cl. B60J 3/04; B60R 16/037; B60W 50/08; G02F 1/01

(52) U.S. Cl. CPC B60J 3/04; B60R 16/037; B60W 50/08; G02F 1/0121

(57) ABSTRACT

Embodiments of the disclosure provide for controlling operation of variable tint (VT) glazing systems of a vehicle. A control system may be configured to: receive an access signal comprising user identification data and indicating a likelihood of a user accessing the vehicle; retrieve user profile data indicative of a tinting configuration of the VT glazing associated with the user identification data; and output a tint control signal indicative of the tinting configuration to control the VT glazing. The control system may be configured to receive a frequency band signal, compare signal with an operating frequency of the system, determine a frequency shift and control the operating frequency of the VT glazing system.

### TECHNICAL FIELD

The present disclosure relates to controlling variable tint glazing of a vehicle and particularly, but not exclusively, to controlling the variable tint glazing of a vehicle to suit user requirements. Certain aspects relate to pre-loading a user configuration of the variable tint glazing. Certain aspects relate to mitigating noise arising from variable tint glazing operations. Aspects of the invention relate to control systems, variable tint glazing systems, distributed systems, vehicles, methods, and computer software.

### BACKGROUND

A vehicle may be equipped with variable tint glazing, wherein the level of tinting (e.g. darkness, or opacity) of the glazing may be varied and controlled. In some cases, it may take time (from a few seconds, e.g. 2-3 seconds, to several tens of seconds, e.g. 40 or 50 s) for the tint of the variable tint glazing to adjust to a set tint level. Different vehicle occupants or drivers may have different preferences for how the glazing is tinted. It may be desirable to control the variable tint glazing in a way which reduces the time spent by a vehicle occupant waiting for the desired glazing tinting to be achieved. It may be desirable to control the variable tint glazing in a way which does not unnecessarily consume power powering the variable tint glazing when the vehicle is not occupied. In some cases, powering variable tint glazing may cause unwanted effects in other powered elements of the vehicle, for example by interference between the power supplied to the glazing and power supplied to, or electronic operation of, other elements of the vehicle. For example, powering the variable tint glazing may cause unwanted audible electronic noise in the vehicle due to interference with other powered elements. It may be desirable to reduce unwanted noise effects arising from operation of variable tint glazing. It is an object of embodiments of the invention to at least mitigate one or more of the problems of the prior art.

### SUMMARY OF THE INVENTION

Aspects and examples disclosed herein of the invention provide control systems, variable tint glazing systems, distributed systems, vehicles, methods, and computer software as claimed in the appended claims.

According to an aspect of the invention, there is provided a control system for a variable tint glazing of a vehicle, the control system comprising one or more controllers, the control system configured to: receive an access signal comprising user identification data, the signal being indicative of a likelihood of a user accessing the vehicle; retrieve user profile data associated with the user identification data in dependence on the access signal, the user profile data indicative of a tinting configuration of at least a portion of the vehicle glazing; and output a tint control signal indicative of the tinting configuration to control the variable tint glazing in dependence on the user profile data.

The one or more controllers may collectively comprise: at least one electronic processor having an electrical input for receiving the access signal; and at least one memory device coupled to the at least one electronic processor and having instructions stored therein; wherein the at least one electronic processor is arranged to access the at least one memory device and execute the instructions stored therein so as to retrieve the user profile data associated with the user identification data; and output the tint control signal.

The variable tint glazing may comprise a plurality of sections; and the user profile data may be indicative of a first tinting configuration for a first section of the variable tint glazing and a second tinting configuration for a second section of the variable tint glazing.

A radio reception frequency of a radio receiver of the vehicle may be stored, and the tinting configuration may comprise an operating frequency of the variable tint glazing which is different to the stored radio reception frequency.

The control system may be configured to compare the radio reception frequency with an operating frequency of the variable tint glazing; determine a frequency shift for the operating frequency in dependence on the comparison; and output a frequency shift signal indicative of the determined frequency shift for controlling the operating frequency of the variable tint glazing.

The control system may be configured to receive a power-on signal in dependence on a power level of the vehicle being set, wherein the power level is indicative of the vehicle being in a ready-to-move state; and output the tint control signal in dependence on receipt of the power-on signal.

The control system may be configured to receive a vacate signal indicative of a user no longer occupying the vehicle; generate a power-off signal arranged to cause the variable tint glazing to be in a dark state in dependence on the vacate signal; and output the power-off signal to the variable tint glazing.

In some examples the power-off signal may cause the variable tint glazing to change to a dark state and maintain the dark state when there is no power supplied to the variable tint glazing. The power-off signal may stop the supply of power to the variable tint glazing in the dark state. The control system may receive a power-off signal in dependence on stopping the supply of power to a traction motor of the vehicle. In some examples the power-off signal may cause the variable tint glazing to change to a clear/transparent state and maintain the clear/transparent state when there is no power supplied to the variable tint glazing. The clear/transparent state may be a high level of transparency (above a transparency threshold) and/or a low tint level (below a threshold tint level), for example. The power-off signal may stop the supply of power to the variable tint glazing in the clear/transparent state. The control system may receive a power-off signal in dependence on, for example, receiving an error state signal, or stopping the supply of power to a traction motor of the vehicle.

The tinting configuration may be a user-selected tinting configuration. The user profile data may comprise one or more of a user-selected tint level of the user; and a last-used tint level associated with the user.

The control system may be configured to retrieve the user profile data from one or more of a memory storage located in the vehicle; and a remote server or cloud.

The control system may comprise: input means arranged to receive the access signal comprising user identification data, the signal being indicative of a likelihood of a user accessing the vehicle; processing means arranged to retrieve the user profile data associated with the user identification data in dependence on the access signal, the user profile data indicative of a tinting configuration of at least a portion of the vehicle glazing; and output means arranged to output the tint control signal indicative of the tinting configuration to control the variable tint glazing in dependence on the user profile data.

As a further aspect there is provided a variable tint glazing system of a vehicle, the system comprising: a control system as disclosed herein; and the variable tint glazing of the vehicle, the variable tint glazing of the vehicle arranged to receive the tint control signal output from the control system and adjust the tint level of the variable tint glazing in dependence on the tint control signal.

The variable tint glazing may form at least part of: a roof of the vehicle; a windscreen of the vehicle; a rear window of the vehicle; and a side window of the vehicle.

The variable tint glazing may comprise a plurality of sections of variable tint glazing; the tint control signal may comprise a plurality of section tint control signals corresponding to the sections of variable tint glazing; a first section of the plurality of sections may be arranged to receive a first section tint control signal and provide a first adjusted tint level in dependence on the first section tint control signal; and a further section of the plurality of sections may be arranged to receive a further section tint control signal and provide a further adjusted tint level in dependence on the further section tint control signal.

The plurality of sections of variable tint glazing may be one or more of: a plurality of sections of variable tint glazing of the vehicle; a plurality of sections of a variable tint glazing roof of the vehicle; a plurality of sections of a variable tint glazing windscreen of the vehicle; a plurality of sections of a variable tint glazing rear window of the vehicle; and a plurality of sections of a variable tint glazing side window of the vehicle.

The variable tint glazing may comprise one or more of: electrochromic glazing, suspended-particle glazing, micro-blind glazing, polymer-dispersed liquid crystal glazing, thermochromic glazing, and photochromic glazing.

As a further aspect there is provided a distributed system for controlling a variable tint glazing of a vehicle, the distributed system comprising: a system as described herein; and at least one access device arranged to transmit the access signal to the control system.

The at least one access device may comprise: a first access device arranged to provide the indication of the likelihood of a user accessing the vehicle; and a further access device arranged to provide the user identification data.

The access device may comprise one or more of: a mobile telecommunication device, a vehicle unlocking device; a key fob, a vehicle key, and a wristband. The access device may comprise both a mobile telecommunication device and a vehicle unlocking device.

The user identification data may be pre-registered to the access device. The access device may be arranged to capture the user identification data in dependence on use of the access device by a user and transmit the captured user identification data to the control system.

The access device comprises an image capture device arranged to: capture an image of the user's face within a predetermined proximity of the vehicle; and provide the captured image of the user's face in the access signal to the control system.

The control system may be configured to: perform facial recognition of the received image of the user's face to identify the user; and retrieve the user profile data in dependence on the facial recognition.

The control system may be configured to receive the access signal in dependence on the access device being located within a predetermined distance from the vehicle. The control system may be configured to receive the access signal in dependence on the access device being determined to be moving towards the vehicle.

The control system may be configured to receive the access signal in dependence on receipt of an unlock signal to unlock the vehicle.

The control system may be configured to receive the access signal in a manual signal transmitted from an access device, the manual signal transmitted intentionally by the user as an indication that the user wishes to adjust the tint level of the variable tint glazing.

As a further aspect, there is provided a method of controlling a variable tint glazing of a vehicle, the method comprising: receiving an access signal comprising user identification data, the signal indicative of a likelihood of a user accessing the vehicle; in dependence on the access signal, retrieving user profile data associated with the user identification data, the user profile data indicative of a tinting configuration of at least a portion of the vehicle glazing; and outputting a tint control signal indicative of the tinting configuration for controlling the variable tint glazing in dependence thereon.

The method may comprise adjusting the tint level of the variable tint glazing to the user-selected tint level in dependence on the tint control signal.

The method may comprise one or more of: determining that an access device is located within a predetermined distance from the vehicle, and receiving the access signal from the access device based on the determination; determining that an access device is located within a predetermined distance from the vehicle and moving towards the vehicle, and receiving the access signal from the access device based on the determination; receiving an unlock signal to unlock the vehicle, and receive the access signal in dependence on receiving the unlock signal; and receiving a manual signal transmitted intentionally by the user as an indication that the user wishes to set the tint level of the variable tint glazing.

The method may comprise: receiving a power-on signal in dependence on a power level of the vehicle being set, wherein the power level is indicative of the vehicle being in a ready-to-move state; and outputting the tint control signal on receipt of the power-on signal.

According to an aspect of the invention, there is provided a control system for a variable tint glazing system of a vehicle, the control system comprising one or more controllers, the control system configured to: receive a frequency band signal indicative of a radio reception frequency of a radio receiver of the vehicle; compare the radio reception frequency with an operating frequency of the variable tint glazing system, and to determine a frequency shift for the operating frequency in dependence on the comparison; and output a frequency shift signal indicative of the determined frequency shift to control the operating frequency of the variable tint glazing system.

The one or more controllers may collectively comprise: at least one electronic processor having an electrical input for receiving the frequency band signal; and at least one memory device coupled to the at least one electronic processor and having instructions stored therein; wherein the at least one electronic processor is arranged to access the at least one memory device and execute the instructions stored therein so as to compare the radio reception frequency with the operating frequency, and to determine the frequency shift for the operating frequency in dependence on the comparison; and output the frequency shift signal.

The radio reception frequency of the radio receiver may comprise at least one band of frequencies.

The frequency shift may, when applied to the operating frequency, shift the operating frequency to be outside the radio reception frequency.

The frequency shift, when applied to the operating frequency, may shift the operating frequency to provide a noise level of an audio output below a threshold audio noise level, the audio output provided by an audio output system of the vehicle in dependence on radio signals received at the radio reception frequency of the radio receiver of the vehicle.

The frequency band signal may indicate an AM frequency band of radio reception. The AM frequency band may be considered to be between about 525 kHz and 1705 kHz.

The control system may be configured to receive the frequency band signal in dependence on receipt of user identification data, the user identification data being indicative of a particular user accessing the vehicle.

The control system may be configured to retrieve user profile data associated with the user identification data, wherein the received frequency band signal is associated with the retrieved user profile data.

The control system may be configured to retrieve the user profile data from one or more of a memory storage located in the vehicle; and a remote server or cloud.

The control system may be configured to receive an access signal indicative of a likelihood of a user accessing the vehicle and retrieve the user profile data in dependence on receipt of the access signal.

The variable tint glazing system may comprise variable tint glazing in a plurality of sections; and the control system may be configured to selectively control powering the plurality of sections of the variable tint glazing.

The control system may be configured to: selectively control powering a first section of the plurality of sections of the variable tint glazing at a first operating frequency, and powering a further section of the plurality of sections of the variable tint glazing at a further operating frequency; compare the radio reception frequency with the first and further operating frequencies, determine a first frequency shift for the first operating frequency in dependence on the comparison, and determine a further frequency shift for the further operating frequency in dependence on the comparison; and output a first frequency shift signal indicative of the first determined frequency shift for controlling the operating frequency of the first section of the variable tint glazing system and output a further frequency shift signal indicative of the further determined frequency shift for controlling the operating frequency of the further section of the variable tint glazing system.

The radio reception frequency may comprise one or more of a user-selected default radio reception frequency; and a last-used radio reception frequency.

The control system may comprise: input means arranged to receive the frequency band signal indicative of a radio reception frequency of a radio receiver of the vehicle; processing means arranged to compare the radio reception frequency with the operating frequency of the variable tint glazing system, and to determine the frequency shift for the operating frequency in dependence on the comparison; and output means arranged to output the frequency shift signal indicative of the determined frequency shift to control the operating frequency of the variable tint glazing system.

As a further aspect, there is provided a variable tint glazing system of a vehicle, the system comprising the control system of any preceding claim, the variable tint glazing of the vehicle, and a variable tint glazing power module arranged to power the variable tint glazing; wherein the variable tint glazing power module is arranged to receive the frequency shift signal output from the control system and adjust the operating frequency of the variable tint glazing power module in dependence on the frequency shift signal.

The variable tint glazing power module may comprise a DC-AC converter arranged to provide AC power to the variable tint glazing at the operating frequency.

The variable tint glazing may form at least part of: a roof of the vehicle; a windscreen of the vehicle; a rear window of the vehicle; and a side window of the vehicle.

The variable tint glazing may comprise one or more of: electrochromic glazing, suspended-particle glazing, micro-blind glazing, polymer-dispersed liquid crystal glazing, thermochromic glazing, and photochromic glazing.

The variable tint glazing system may comprise a high voltage, HV, wire connected between the variable tint glazing power module and the variable tint glazing, and a ferrite located on the HV wire.

The variable tint glazing system may comprise a low voltage, LV, wire connected between the variable tint glazing power module and a power supply of the vehicle, and a ferrite located on the LV wire. The LV wire may be a wiring harness. The LV wire may be a plurality of triple-twisted wires in some examples. The power supply of the vehicle may be a body domain module, body control module or body power module, or a relay, for example.

As a further aspect, there is provided a vehicle comprising any control system described herein, or any system described herein.

As a further aspect, there is provided a method of controlling a variable tint glazing of a vehicle, the method comprising: receiving a frequency band signal indicative of a radio reception frequency of a radio receiver of the vehicle; comparing the radio reception frequency with an operating frequency of the variable tint glazing system; determining a frequency shift for the operating frequency in dependence on the comparison and outputting a frequency shift signal indicative of the determined frequency shift for controlling the operating frequency of the variable tint glazing system.

The method may comprise, during audio output provided by an audio output system of the vehicle, the audio output provided in dependence on radio signals received at the radio reception frequency of the radio receiver of the vehicle, applying the frequency shift to the operating frequency to shift the operating frequency to be outside the radio reception frequency.

The method may comprise determining the frequency shift by one or more of: calculating, in dependence on the operating frequency of the variable tint glazing system and the radio reception frequency, the frequency shift; and retrieving the frequency shift from a look up table, wherein the frequency shift is predetermined to correspond to the radio reception frequency.

As a further aspect, there is provided computer software which, when executed by a processor, is arranged to cause the processor to perform any method disclosed herein. The computer software may be stored on a computer-readable medium. The computer software may be stored on a non-transient computer-readable medium. The computer software may be called instructions or computer-readable instructions.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

In a further aspect of the invention there is provided a vehicle comprising variable tint glazing, wherein the variable tint glazing comprises a plurality of sections, wherein the plurality of sections are independently controllable to different tint levels. Advantageously, this allows a user of the vehicle to control the level of light in different areas of the cabin of the vehicle independently from one another. For example, the variable tint glazing associated with the front of the cabin of the vehicle may be configured to allow a high level of light into the cabin of the vehicle, whilst the variable tint glazing associated with the rear of the cabin of the vehicle may be configured to allow a low level of light into the vehicle. Subsequently, the variable tint glazing may be re-configured to enable a high level of light to be associated with the rear of the cabin of the vehicle, whilst also enabling a low level of light to be associated with the front of the cabin of the vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a control system for variable tint (VT) glazing of a vehicle according to an embodiment of the invention;

FIG. 2 schematically shows a control system according to an embodiment of the invention;

FIG. 3 illustrates schematically VT glazing comprising a plurality of sections according to an embodiment of the invention;

FIG. 4 illustrates a control system and sectioned VT glazing according to an embodiment of the invention;

FIG. 5 shows a control system for VT glazing of a vehicle using a radio reception frequency of a radio receiver of the vehicle according to an embodiment of the invention;

FIG. 6 shows a control system for VT glazing of a vehicle using user profile data according to an embodiment of the invention;

FIG. 7 illustrates a staged control of VT glazing due to different power states of a vehicle according to an embodiment of the invention;

FIG. 8 illustrates a distributed system comprising an access device according to an embodiment of the invention;

FIG. 9 shows a user approaching a vehicle according to an embodiment of the invention;

FIG. 10 illustrates a method 1000 according to an embodiment of the invention;

FIG. 11 shows a control system for VT glazing of a vehicle according to an embodiment of the invention;

FIG. 12 shows a control system using user ID data according to an embodiment of the invention;

FIG. 13 shows a VT glazing system of a vehicle according to an embodiment of the invention;

FIG. 14 shows a VT glazing system of a vehicle comprising a ferrite according to an embodiment of the invention; and

FIG. 15 illustrates a method 1100 according to an embodiment of the invention;

and

FIG. 16 illustrates a vehicle 1600 according to an embodiment of the invention.

### DETAILED DESCRIPTION

A vehicle may be equipped with variable tint glazing, wherein the level of tinting (e.g. darkness, or opacity) of the glazing may be varied and controlled. Different vehicle occupants or drivers may have different preferences for how the glazing is tinted. Controlling the variable tint glazing to suit a particular user's preferences, in an automated and convenient way for the user, while mitigating against unnecessarily consuming power powering the variable tint glazing, may be achieved by examples disclosed herein.

Examples disclosed herein may apply, for example, to a roof system (which may be termed a “panoramic sunroof”) of a vehicle. Variable tint glazing technology allows for the light transition through the roof glass to be altered, for example from a dark to light state. Examples disclosed herein allow for the personalisation of the variable tint glazing settings. A user's individual settings/preferences for the glazing tinting may be stored and linked to the user, for example in individual user key fobs or through otherwise retrieving stored personal settings. This enables the user's preferences to be stored and implemented, for example when the user approaches or uses the vehicle, to personalise the vehicle glazing tinting to the user's preference. Discussions of “tint level” may also be considered to apply to “opacity”. Hence, in examples discussing glazing in a dark state, such examples may also apply to an opaque glass state, i.e. the glass is more difficult for light to pass through in some respect (e.g. light is absorbed or scattered). In examples discussing glazing in a clear or transparent state in which no or low glazing tinting/darkening is present, such examples may also apply to a non-opaque glass state, i.e. the glass is easier for light to pass through in some respect (e.g. very little light is absorbed or scattered).

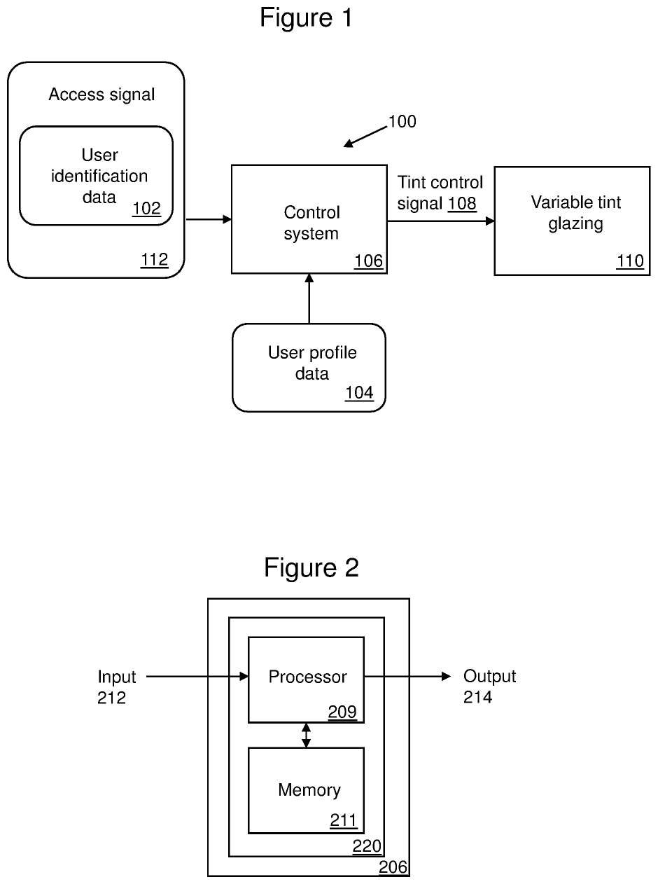

FIG. 1 shows a system 100 comprising a control system 106 for variable tint (VT) glazing of a vehicle according to an embodiment of the invention. The control system 106 comprises one or more controllers, as described in more detail in relation to FIG. 2. The control system 106 is configured to receive an access signal 112 comprising user identification data 102. The access signal 112 is indicative of a likelihood of a user accessing the vehicle. The control system 106 may comprise input means arranged to receive the access signal 112 comprising the user identification data 102. An access signal may be transmitted, for example, by a user approaching the vehicle with a detectable device linked to that user, such as a personal car key, key fob, or other portable user electronic device; or by a user transmitting an “unlock” command to the vehicle from a device registered to or associated with that user, for example. This is described in more detail with reference to FIGS. 6-9.

The control system 106 is configured to retrieve user profile data 104 associated with the user identification data 102 in dependence on the access signal 112. The user profile data 104 is indicative of a tinting configuration of at least a portion of the vehicle glazing 110. The control system 106 may comprise processing means arranged to retrieve the user profile data 104 associated with the user identification data 102 in dependence on the access signal 112. The user profile data may indicate a user preference or predetermined setting for that user of the tinting configuration of the VT glazing of the vehicle.

In some examples the tinting configuration may be a user-selected tinting configuration. In some examples the user profile data 104 may comprise a user-selected tint level of the user (e.g. a preset user preference for glazing tinting). In some examples the user profile data 104 may comprise a last-used tint level associated with the user. That is, when a user occupies the vehicle and a tinting configuration is implemented to tint the VT glazing in a particular way, that tinting configuration may be stored and associated with the user who made the setting for retrieval the next time that the user is identified as being likely to occupy the vehicle. The control system 106 may be configured to retrieve the user profile data 104 from a memory storage located in the vehicle, from a remote server, or from the “cloud”, for example.

The control system 106 is configured to output a tint control signal 108 indicative of the tinting configuration to control the variable tint glazing 110 in dependence on the user profile data 104. The control system 106 may comprise output means arranged to output the tint control signal 108 indicative of the tinting configuration. The tint control signal 108 may be provided to a power supply of the VT glazing, for example, to cause the VT glazing to be powered and tint the glazing according to the user's profile data.

In this way, a personalised and automated control of VT glazing may be achieved, in response to a user indicating that they are likely to be accessing the vehicle (and thus would have a preference for the VT glazing to have a tinting configuration which suits them). By generating and providing the output signal following recognition that the user is likely to access the vehicle, the VT glazing may be controlled in advance of the user entering the vehicle, so the VT glazing is tinted according to the user profile data in time for when the user does access the vehicle. To conserve power, however, the control system does not perform the determination of a tinting configuration nor is any tint control signal generated or output unless there is an indication provided that the user is likely to access the vehicle in the near future.

FIG. 2 schematically shows a control system 206 according to an embodiment of the invention. The one or more controllers 220 of the control system 206 may collectively comprise: at least one electronic processor 209 having an electrical input 212 for receiving the access signal 112; and at least one memory device 211 coupled to the at least one electronic processor 209 and having instructions stored therein. The at least one electronic processor 209 is arranged to access the at least one memory device 211 and execute the instructions stored therein so as to retrieve the user profile data 104 associated with the user identification data, and output the tint control signal 108.

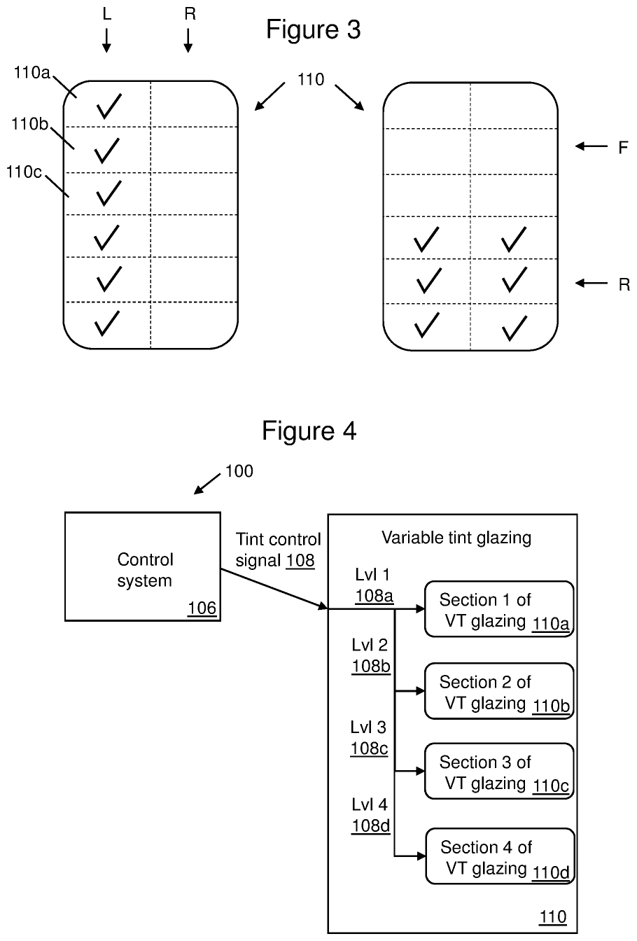

FIG. 3 illustrates schematically VT glazing 110 comprising a plurality of sections 110a, b, c. The illustrated glazing may be a view looking down onto the top of a vehicle and the VT glazing forms at least a part of the vehicle roof, for example. In this example, the vehicle roof may comprise a VT glazing panel 110 which is made up of a plurality of VT glazing sections 110a, b, c. The VT glazing may be controlled, for example, so that one side (e.g. left side L as the driver faces) is darkened compared to the other (right R) side of the VT glazing roof. This may be desirable if, for example, a passenger seated on the left wishes to rest or sleep, or if the sun is shining through the left of the vehicle to try and reduce cabin temperature. As another example, the VT glazing may be controlled, for example, so that the rear portion B (e.g. located over the passengers in the rear of the vehicle) is darkened compared to the front portion F (over where the driver is located) of the VT glazing roof. This may be desirable if, for example, the rear-seated passengers wish to rest or sleep. In other examples, the VT glazing may form at least part of a windscreen of the vehicle, a rear window of the vehicle, and/or a side window of the vehicle, for example.

In examples in which the VT glazing 110 comprises a plurality of sections 110a, b c as in FIG. 3, the user profile data which is retrieved may indicate a first tinting configuration for a first section of the VT glazing 110 and a second tinting configuration for a second section of the VT glazing 110. In the example of darkening the glazing on the left L of the cabin as shown in FIG. 3, the user profile data may indicate a first (darker, e.g. 50% dark) tinting configuration for a first (left L) section of the VT glazing 110 and a second (e.g. lighter, e.g. 10% dark) tinting configuration for a second (right R) section of the VT glazing 110.

In some examples, an application may be operated on a personal electronic device, such as a mobile telephone or tablet. The application may allow the user to select and de-select VT glazing sections, and set in the application what level of tinting each section should have. For example, the application may run on a touch screen device, and the user may be presented with an image representing the sectioned VT glazing (similar to the illustrations in FIG. 3, for example). The application may be configured to receive a touch user input on a portion of the screen corresponding to a particular section of the VT glazing. The control system may be configured to cause a tint control signal to be generated which corresponds to the setting provided by the user's touch input to control the tint level of the corresponding section of VT glazing of the vehicle. Of course, other user inputs may be envisioned to select a tinting configuration. The action of the user opening the application, using the application, or providing a signal through the application to “make tinting setting now” or similar, may be the indication that the user is likely to access the vehicle and as such cause the control system to determine the tint control signal and output it for control of the VT glazing according to the user's selected setting in the application.

FIG. 4 illustrates a control system 106 and sectioned VT glazing 110, for example as shown in FIG. 3. For example, section 1 of the VT glazing may be a front left portion of a VT glazed roof, section 2 of the VT glazing may be a front right portion of a VT glazed roof, section 3 of the VT glazing may be a back left portion of a VT glazed roof, and section 4 of the VT glazing may be a back right portion of a VT glazed roof. As another example, the sectioned VT glazing may be considered to be (possibly physically) separate glazing sections such as separate windows, such that section 1 of the VT glazing may be a front left passenger side window of a VT glazed roof, section 2 of the VT glazing may be a front right driver side window of a VT glazed roof, section 3 of the VT glazing may be a back left passenger side window of a VT glazed roof, and section 4 of the VT glazing may be a back right passenger side window of a VT glazed roof. In other words, the plurality of sections of variable tint glazing may be one or more of, for example: a plurality of sections of variable tint glazing of the vehicle; a plurality of sections of a variable tint glazing roof of the vehicle; a plurality of sections of a variable tint glazing windscreen of the vehicle; a plurality of sections of a variable tint glazing rear window of the vehicle; and a plurality of sections of a variable tint glazing side window of the vehicle.

The control system 106 and VT glazing 110 (whether a single panel, a sectioned panel, or physically separate glazing panels/windows) together may be called a VT glazing system 100 of a vehicle. The VT glazing 110 of the vehicle may be arranged to receive the tint control signal 108 output from the control system 106 and adjust the tint level of the VT glazing 110 in dependence on the tint control signal 108. The example of FIG. 4 shows VT glazing 110 which comprises a plurality of sections 110a-d of VT glazing, and the tint control signal 108 comprises a plurality of section tint control signals 108a-d corresponding to the sections 110a-d of VT glazing 110. A first section 110a of the plurality of sections in this example is arranged to receive a first section tint control signal 108a and provide a first adjusted tint level in dependence on the first section tint control signal 108a, and a further section 110b; 110c; 110d of the plurality of sections is arranged to receive a further section tint control signal 108b; 108c; 108d, and provide a further adjusted tint level in dependence on the further section tint control signal 108b; 108c; 108d.

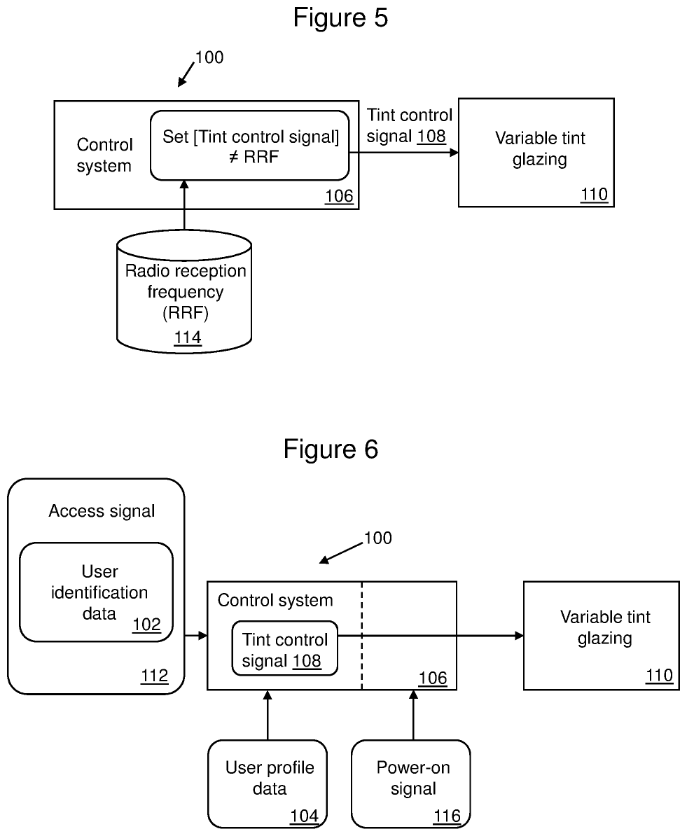

FIG. 5 shows a control system for VT glazing of a vehicle, which considers the operation of a radio receiver of a vehicle (i.e. an in-vehicle radio so the driver/passengers can listen to AM or FM radio broadcasts in the vehicle). In some examples, the VT glazing 110 may operate using an AC power supply. In some cases, the frequency of the VT glazing 110 AC power supply can interfere with the received radio signals, and the audio output can include unwanted noise due to the interference. Some examples disclosed here provide for operating VT glazing and providing audio output from received radio signals in a way which reduces unwanted noise in the audio output.

FIG. 5 shows that a radio reception frequency, RRF, 114 of a radio receiver of the vehicle may be stored (for example, at a memory located at the vehicle). The tinting configuration indicated by the tint control signal 108 and provided by the control system 106 may comprise an operating frequency of the VT glazing 110 which is different to the stored radio reception frequency 114. By having a different operating frequency of VT glazing to the RRF 114, the noise in the audio output provided from received radio signals at the RRF may be reduced.

The control system 106 may be configured to compare the RRF 114 with an operating frequency of the VT glazing 110, determine a frequency shift for the operating frequency in dependence on the comparison, and output a frequency shift signal indicative of the determined frequency shift for controlling the operating frequency of the VT glazing 110. For example, if the comparison indicates that the RRF and the VT glazing operating frequency overlap, then a frequency shift may be applied to the VT glazing operating frequency so there is no longer an overlap in frequency. FIG. 5 shows this process as “Set [Tint control signal RRF]”, by which the tint control signal 108 is shifted away from the RRF according to the frequency shift signal by the determined frequency shift.

FIG. 6 shows a system 100 comprising a control system 106 for VT glazing 110 of a vehicle. As in FIG. 1, the control system 106 is configured to receive an access signal 112 comprising user identification data 102. The control system 106 is configured to then retrieve user profile data 104 associated with the user identification data 102. The user profile data 104 is indicative of a tinting configuration of at least a portion of the vehicle glazing 110. The control system 106 is configured to output a tint control signal 108 indicative of the tinting configuration to control the variable tint glazing 110 in dependence on the user profile data 104.

In this example, the control system 106 may be configured to retrieve the user profile data 104 upon the user approaching the vehicle, but at this stage the tint control signal 108 may be stored, or buffered, in preparation for transmission to the VT glazing without yet being transmitted. The control system 106 in this example is configured to receive a power-on signal 116 in dependence on a power level of the vehicle being set. The power level is indicative of the vehicle being in a ready-to-move state. This “ready-to-move” state may be, for example, the engine of the vehicle being started, the user unlocking the vehicle to allow for entry into the vehicle, or the vehicle being moved into a “ready” state whereby the vehicle is operable to be controlled to some extent though the engine is not yet running, for example. The control system 106 is configured to output the tint control signal 108 in dependence on receipt of the power-on signal 116. This example of FIG. 6 may be considered to be “staged” control of the VT glazing, whereby the control system 106 is arranged to “prime” the operation state of the VT glazing system to be ready to change tinting configuration, for example, upon user approach or vehicle unlock, but the VT glazing is actually operated by provision of the tinting configuration to control/change the tinting of the VT glazing once the vehicle is “switched on” to be in a ready-to-move state. Such stages operation may be performed to reduce the amount of time the user needs to wait for their tinting configuration to be applied, while also reducing the amount of power required to operate the VT glazing system.

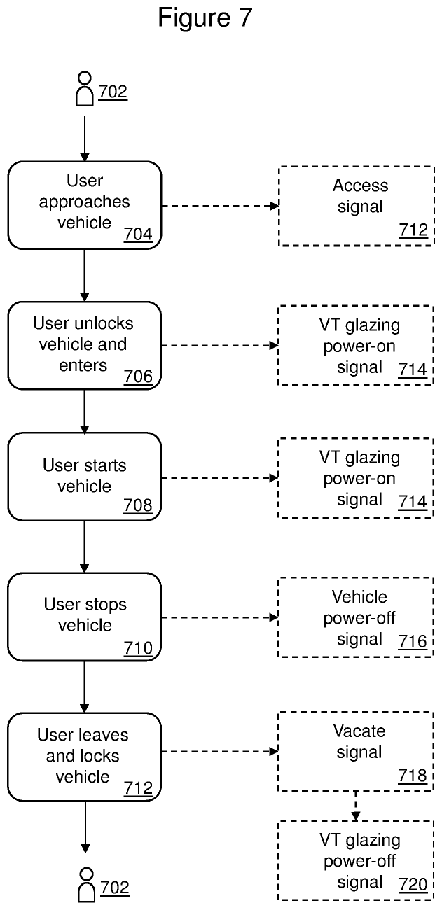

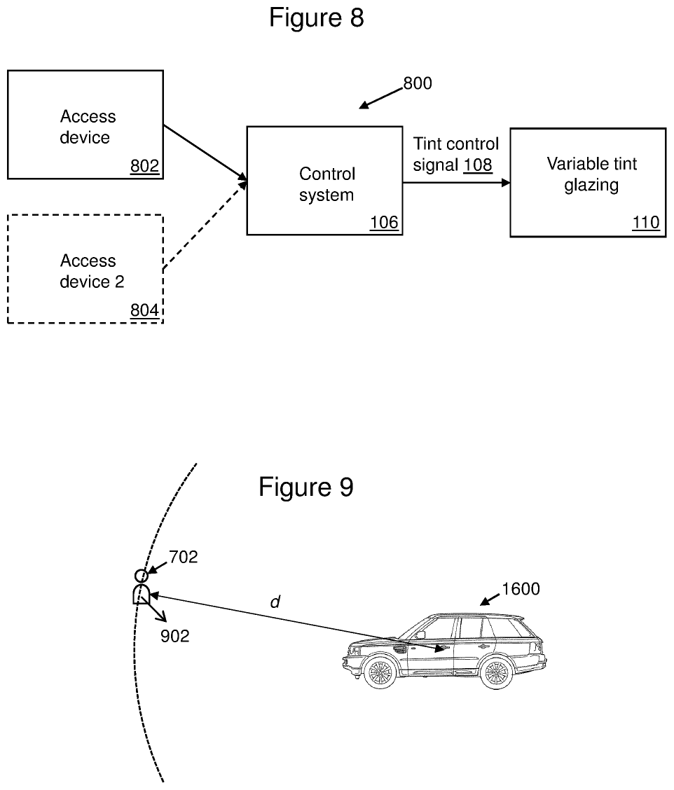

FIG. 7 illustrates an example of staged control of VT glazing according to different power states of a vehicle. A user 702 approaches their vehicle 704. The user approach (as discussed below in relation to FIG. 8) causes the transmission of an access signal 712 to the control system of the VT glazing system. The access signal 712 comprises user identification data and is indicative of the likelihood of a user 702 accessing the vehicle. The access signal 712 may cause the VT control system to retrieve the user profile data which indicates a tinting configuration for that user. However, because the user has not yet unlocked or entered the vehicle, no control of the VT glazing has yet taken place. By priming the VT glazing system by retrieving the user profile data (and as such the tinting configuration for the approaching user), if the user does enter/use the vehicle, the VT glazing may be adjusted simply by sending the tint control signal. However, the VT glazing is not actively controlled only by the approach of the user in this example, which may be undesirable if the user is simply walking past the vehicle, for example.

Next, the user 702 unlocks and enters the vehicle 706. In this example, the act of unlocking the vehicle 706 is taken as an indication that the user 702 is going to use/enter the vehicle, and as such may cause a primed “VT glazing power-on signal” 714 to be transmitted to the control system and cause the VT glazing to be adjusted according to the tint control signal. In this way, the VT glazing is operated according to a tinting configuration which is linked to the user entering the vehicle 706. Moreover, the VT glazing is in the tinting configuration for that user before the user 706 starts the vehicle in this example, so the VT glazing is ready for when the user does start the vehicle, but after the user has provided some confirmation (via unlocking and entering the vehicle 706) that the user is going to use the vehicle (rather than, for example, the user simply walking past the vehicle without the intention of entering at that time).

In some examples, the “VT glazing power-on signal” 714 may be transmitted to the control system and cause the VT glazing to be adjusted according to the tint control signal in dependence on the vehicle being started 708 (e.g. the user starts the engine to move the “power” or “power mode” state of the vehicle up from “ready” to “operable”, for example). In this example, the VT glazing is moved into a tinting configuration for the user after the user 702 starts the vehicle, so the VT glazing is only adjusted just prior to the user driving the vehicle. This may save power, for example, compared with powering the VT glazing system while the user is in the vehicle but is not driving (for example, they are loading shopping into the vehicle, or taking a phone call before driving).

In some examples, the user(s) of the vehicle may be able to configure the operation of the VT glazing system according to their preference, so that the VT glazing system is powered and controlled according to the tinting configuration when the vehicle is in a particular state which suits the user. For example, one user may prefer the VT glazing to have a tinting configuration of their preference ready before the user enters the vehicle, and as such the tint control signal may be provided to the VT glazing system upon vehicle unlock by that user. Another user may instead prefer that the VT glazing system is not adjusted (i.e. the tinting configuration is not changed to suit that user) until the user starts the vehicle, for example because the user usually takes a work call before setting off driving. The user's preference for when the tint control signal is transmitted to the VT glazing system may be stored in the user's user profile data in some examples.

When the user stops the vehicle 710 (i.e. stops the power to the engine, or the user stops the engine to move the “power” or “power mode” state of the vehicle down from “operable” to “ready”, for example) a “vehicle power-off signal” 716 may be generated and transmitted to the control system. The “vehicle power-off signal” 716 may cause the VT glazing to be adjusted according to the tint control signal in dependence on the vehicle being stopped 710. The VT glazing in this example is controlled to remain in the tinting configuration for the user after the user 702 stops the vehicle (but before the user vacates the vehicle), so the VT glazing remains at the user's preferred setting while the user is still occupying the vehicle.

When the user leaves and locks the vehicle 712 (i.e. opens the door to leave the vehicle, and/or locks the vehicle after leaving) the VT glazing may receive a “vacate” signal 718 which triggers stopping the supply of power to the VT glazing. That is, the control system may be configured to receive a vacate signal 718 indicative of a user no longer occupying the vehicle 712.

In some examples, the control system may generate a power-off signal 720 arranged to cause the variable tint glazing to be in a dark state in dependence on the vacate signal 718, and output the power-off signal 720 to the variable tint glazing. A dark state may be defined as a level of tinting (i.e. dark shading) of the VT glazing which is above a predetermined level (e.g. above 50% shading, or above 80% shading, for example). A dark state may be desirable when the vehicle is not occupied to improve vehicle security (since it is more difficult for a potential thief to look inside a vehicle to identify valuables to steal).

In some examples, the VT glazing may default to a transparent state when no power is supplied (a transparent state may be defined as a level of tinting (i.e. dark shading) of the VT glazing which is below a predetermined level (e.g. below 50% shading, or below 20% shading, for example). The control system may generate a power-off signal 720 arranged to cause the variable tint glazing to be in a transparent state in dependence on the vacate signal 718, and output the power-off signal 720 to the variable tint glazing. If the VT glazing is configured to be in a transparent state when no power is supplied to it then this may be a desirable mode of operation of the VT glazing to save power when the vehicle is not in use. In some examples, the VT glazing may default to a dark state when no power is supplied in other examples.

In some examples the VT glazing may default to a transparent state when no power is supplied, for example as a failsafe mode due to a fault. That is, for example if the VT glazing forms part of the vehicle glazing which it is important to be able to see through clearly for safety, e.g. the windscreen, then the VT glazing may be configured to default to a transparent/clear state if there is no power supplied, in case of a power failure while driving so the driver can still clearly see to control the vehicle safely.

In some examples, the power-off signal 720 may cause the variable tint glazing to change to a light or transparent state and maintain the transparent state when there is no power supplied to the variable tint glazing. The power-off signal 720 may stop the supply of power to the variable tint glazing in the transparent state. The control system may receive a power-off signal 720 in dependence on stopping the supply of power to a traction motor of the vehicle.

In some examples, the tinting configuration may be transmitted, or not, according to one or more environmental factors. For example, if it is determined (e.g. by a light detection sensor) that it is dark outside, then this may cause the VT glazing system to remain transparent without a tint being applied even if the tinting configuration indicates that tinting/darkening should be performed. If, during vehicle operation, the environment brightens (e.g. the vehicle is being driven from early morning when it is dark, through to later in the morning when it is bright), then the VT glazing system may be controlled according to the tint control signal corresponding to the tinting configuration for the driving user upon a predetermined level of environmental brightness being detected. That is, as the environment becomes brighter, the tint level of the VT glazing may darken until the tinting configuration of the user profile data of the driver is achieved. As another example, a rain sensor or other environmental sensor may be present on the vehicle which may also detect the ambient light conditions and ambience of the environment outside, and the detected light conditions may be used to control the tinting configuration of the VT glazing, and in some examples, control one or more other vehicle features such as internal and/or external lighting features.

FIG. 8 illustrates a distributed system 800 for controlling a variable tint glazing 110 of a vehicle. The distributed system 800 comprises a system of a control system 106 and VT tint glazing 110, and at least one access device 802, 804 arranged to transmit the access signal to the control system 106. In this example, there is at least one access device 802; there may be two, or more, access devices 804 in some examples. The access device 802, 804 may be, for example, a mobile telecommunication device such as a smartphone or smart watch, or a vehicle unlocking device such as a key fob, a vehicle key, and a wristband.

The access device 802, 804 may, as illustrated in this example, comprise a first access device 802 arranged to provide the indication of the likelihood of a user accessing the vehicle; and a further access device 804 arranged to provide the user identification data. The at least one access device may be a plurality of access devices 802, 804, comprising both a mobile telecommunication device (e.g. a smartphone) and a vehicle unlocking device. For example, a user may unlock the vehicle using a key fob as a first access device 802, and may confirm his or her identity using a smartphone as the second access device 804.

The user identification data may be pre-registered to the access device 802, 804 in some examples. For example, a key fob, wristband, or smartphone (i.e. the user's access device) may be pre-registered to a particular user. When the access device 802, 804 is detected, for example, detected within a predetermined distance of the vehicle, the corresponding user profile data is retrieved as a result, to pre-empt that user accessing the vehicle and so the VT glazing may be controlled to provide a tinting configuration for that user.

In some examples, the access device 802, 804 may be arranged to capture the user identification data in dependence on use of the access device 802, 804 by a user, and transmit the captured user identification data to the control system. For example, the vehicle key or key fob may comprise a fingerprint scanner. When a user presses the key/key fob to unlock the vehicle with their fingertip or finger pad (or the user may simply hold the key using their fingers), the user's fingerprint may be scanned/captured and transmitted to a fingerprint storage which retrieves the identity of the user and thus the user profile data. Other biometric identification methods may also be similarly employed.

In some examples, the access device 802, 804 may comprise an image capture device arranged to capture an image of the user's face within a predetermined proximity of the vehicle, and provide the captured image of the user's face in the access signal to the control system 106. For example the access device 802, 804 may be a camera located at the vehicle and facing outwards from the vehicle to capture images of a person approaching the vehicle. The control system 106 may be configured to then perform facial recognition of the received image of the user's face to identify the user; and retrieve the user profile data in dependence on the facial recognition. Facial recognition may, in some examples, be performed at a remote server or cloud, so that the users facial image is transmitted to that remote server or cloud, which performs facial recognition and identifies the user, then the user identifier may be transmitted to the control system 106 in some examples to retrieve the user profile data, or the user identifier may be used at the or another remote server, or cloud, to retrieve the user profile data from there and transmit the user profile data (or at least transmit the tinting configuration from the user profile data) to the control system.

FIG. 9 shows a user 702 approaching 902 a vehicle 1600. In some examples, the control system may be configured to receive the access signal in dependence on the access device (located with the user) being located within a predetermined distance d from the vehicle 1600. The location of the user 702 within a predetermined distance d may be taken as an indication that the user 702 intends to use the vehicle 1600 so the VT glazing may be operated according to the user preferences. In some examples, the control system may be configured to receive the access signal in dependence on the access device being determined to be moving towards 902 the vehicle. In this way, if the user is walking past the vehicle, no action is necessarily taken to control the VT glazing, but if the user is moving toward the vehicle, then this may be taken as an indication that the user 702 intends to use the vehicle 1600 rather than simply walking past it. The control system may be configured to receive the access signal in dependence on receipt of an unlock signal to unlock the vehicle in some examples. In this way, the user provides a signal indicating an intention of using the vehicle i.e. the vehicle is being unlocked. The control system in some examples may be configured to receive the access signal in a manual signal transmitted from an access device 802, 804, the manual signal transmitted intentionally by the user as an indication that the user wishes to adjust the tint level of the variable tint glazing. This allows the user to have a manual control of the vehicle's VT glazing. For example, it may be a very hot day, and the user may wish to darken the tint of the VT glazing in advance of occupying the vehicle at a later time (e.g. 1-2 hours later) to help prevent the cabin temperature becoming too hot.

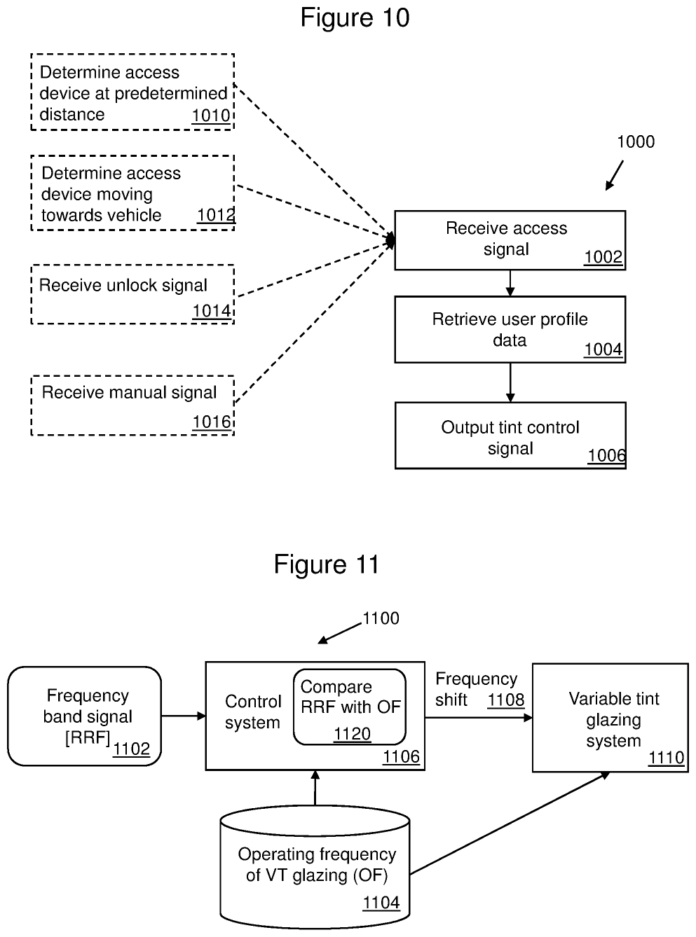

FIG. 10 illustrates a method 1000 of controlling a VT glazing of a vehicle. The method 1000 comprises receiving an access signal comprising user identification data 1002. The signal is indicative of a likelihood of a user accessing the vehicle. In dependence on the access signal, the method comprises retrieving user profile data 1004 associated with the user identification data. The user profile data is indicative of a tinting configuration of at least a portion of the vehicle glazing. The method comprises outputting a tint control signal 1006 indicative of the tinting configuration for controlling the variable tint glazing in dependence thereon. In some examples, the method 1000 comprises adjusting the tint level of the variable tint glazing to the user-selected tint level in dependence on the tint control signal.

The method 1000 may comprise one or more of: determining that an access device is located within a predetermined distance from the vehicle, and receiving the access signal from the access device based on the determination 1010; determining that an access device is located within a predetermined distance from the vehicle and moving towards the vehicle, and receiving the access signal from the access device based on the determination 1012; receiving an unlock signal to unlock the vehicle, and receive the access signal in dependence on receiving the unlock signal 1014; and receiving a manual signal transmitted intentionally by the user as an indication that the user wishes to set the tint level of the variable tint glazing 1016. This is discussed more in relation to FIGS. 8 and 9.

The method 1000 may comprise, in some examples, receiving a power-on signal in dependence on a power level of the vehicle being set, wherein the power level is indicative of the vehicle being in a ready-to-move state; and outputting the tint control signal on receipt of the power-on signal. This is discussed more in relation to FIGS. 6 and 7.

In some examples, the provision of a tint control signal (or, for example, a switching signal related to the tint control signal) which is to control the VT glazing tint level may be a continuous provision. That is, the VT glazing tint level may be set and maintained during provision of the tint control signal (or related switching signal), and when the tint control signal (or related switching signal) ceases to be provided, the VT glazing tint level reverts to a default tint state (e.g. transparent, or e.g. dark). This example may be considered to be a requirement for a permanent signal provision to maintain a particular tint level. In some examples, the provision of a tint control signal (or, for example, a switching signal related to the tint control signal) which is to control the VT glazing tint level may be a momentary provision. That is, the VT glazing tint level may be set by provision of the momentary (i.e. time-limited, short-lived, or instantaneous) tint control signal (or related switching signal), and maintained after the tint control signal (or related switching signal) has been provided until another control signal is received to change the VT glazing tint level to a different tinting configuration. This may be considered to be a requirement for a momentary signal provision to set a particular tint level which is maintained until another control signal is received.

While this disclosure focusses on personalisation and control of VT glazing, other personalisable elements of a vehicle may be similarly controlled, such as steering column position, seat position, radio station, ambient lighting, or other adjustable elements of the vehicle, to provide an enhanced user experience through automation of personalisation of the vehicle components.

In some examples, the VT glazing may be powered by an AC current, for example through a DC-AC converter. There may be radio interference in the AM band due to the AC current powering the VT glazing. In some cases one or more AM frequency bands, when tuned, combined with the use of the VT glazing of the vehicle, can cause undesirable audible interference. Examples disclosed herein may address the problem of audible interference in an audio output from a radio due to operation of VT glazing as disclosed herein.

FIG. 11 shows a control system 1100 for VT glazing of a vehicle. The control system 1100 comprises one or more controllers, and the control system 1100 is configured to receive a frequency band (FB) signal 1102 indicative of a radio reception frequency (RRF) of a radio receiver of the vehicle. The control system 1100 is configured to compare the radio reception frequency with an operating frequency 1104 of the variable tint glazing system. The control system 1100 is configured to determine a frequency shift for the operating frequency 1104 in dependence on the comparison, and output a frequency shift signal 1108 indicative of the determined frequency shift to control the operating frequency of the variable tint glazing system 1110.

The VT glazing may be powered by AC current, for example 120V AC, from a DC-AC converter configured to convert DC supplied power to an AC current to power the VT glazing. The control system 1106 shown in FIG. 11 may rapidly and adaptively/intelligently shift the fundamental frequency of the DC-AC converter, for example, to move the noise out of the tuned radio frequency (e.g. AM frequency) of the radio receiver to mitigate audible noise arising from electrical interference.

The control systems described herein may allow for the reduction of noise interference in audio produced from received radio signals, in a software-based way. That is, no additional or special hardware is required to perform the frequency shift to reduce the audible noise, thereby no redesign of the vehicle electronic hardware is necessary. Further, no hardware components are required which do not comply with automotive standards, which would result in a complicated and expensive system to implement practically.

FIG. 11 shows the frequency shift signal 1108 indicating a change in operating frequency of the VT glazing system being provided from the control system 1106 to the VT glazing system 1110, and the VT glazing system 1110 also receives the operating frequency 1104 of the variable tint glazing system 1110, so that the step of shifting the operating frequency 1104 of the variable tint glazing system 1110 by the frequency shift 1108 is performed at the VT glazing system 1110 (e.g. at a power supply of the VT glazing system 1110). In some examples, the control system may apply the frequency shift 1108 to the operating frequency 1104 of the VT glazing system and provide an indication of the shifted operating frequency to the VT glazing system so that the VT glazing system can operate at that shifted operating frequency. In some examples, the shifted operating frequency to the VT glazing system may be determined at a further module separate from the control module 1106 and the VT glazing system 1110 and supplied to the VT glazing system 1110.

The one or more controllers of the control system 1100 may collectively comprise: at least one electronic processor 209 having an electrical input 212 for receiving the frequency band signal 1102; and at least one memory device 211 coupled to the at least one electronic processor 209 and having instructions stored therein; wherein the at least one electronic processor 209 is arranged to access the at least one memory device 211 and execute the instructions stored therein so as to compare the radio reception frequency with the operating frequency 1104, and to determine the frequency shift for the operating frequency in dependence on the comparison; and output the frequency shift signal 1108. Such a system is illustrated in FIG. 2.

The frequency band signal may indicate an AM frequency band of radio reception in some examples. The AM frequency band may be considered to be between about 525 kHz and 1705 kHz (e.g. ±20 kHz at either end of this range). The frequency band signal may indicate an FM frequency band of radio reception in some examples. The FM frequency band may be considered to be between, for example, 30 MHz to 300 MHz; e.g. from 87.5 MHz to 108 MHz (also known as VHF Band II); from 88 MHz to 108 MHz (also known as ITU region 2); from 76 MHz to 95 MHz (as used for FM broadcasts in Japan), or from 65.8 MHz to 74.0 MHz (OIRT band). The radio reception frequency (RRF) of the radio receiver may comprise at least one band of frequencies. For example, a frequency band may be 985-995 kHz AM or 1012-1014 kHz AM. Other radio reception frequencies may be indicated by the frequency band signal. The radio reception frequency 1102 may comprise a user-selected default radio reception frequency (e.g. a frequency corresponding to a favourite radio broadcast station of that user, which may be indicated in a user profile data for that user) and/or and a last-used radio reception frequency (e.g. a frequency at which the radio receiver was last tuned).

The frequency shift 1108 may, when applied to the operating frequency 1104, shift the operating frequency 1104 to be outside the radio reception frequency 1102. For example, if the operating frequency of the VT glazing 1104 is 1000 kHz, and the radio reception frequency 1102 is a band of 999 kHz to 1003 kHz AM, then the frequency shift 1108 may be −2 kHz to take the operating frequency of the VT glazing 1104 to 998 kHz; or, the frequency shift 1108 may be +5 kHz to take the operating frequency of the VT glazing 1104 to 1005 kHz, to be outside the radio reception frequency 1102. In other examples, a difference of greater (or less) than 1 kHz between the shifted operating frequency of the VT glazing system and the AM RRF may be generated, for example, to further reduce interference.

Audio output (e.g. music or speech broadcast by a radio station) may be provided by an audio output system (e.g. a speaker) of the vehicle in dependence on radio signals received at the radio reception frequency of the radio receiver of the vehicle. The frequency shift, when applied to the operating frequency 1104, may shift the operating frequency to provide a noise level in the audio output below a threshold audio noise level.

The variable tint glazing system 1100 may comprise variable tint glazing in a plurality of sections, as illustrated in FIGS. 3 and 4. The control system 1106 may be configured to selectively control powering the plurality of sections of the variable tint glazing. For example, the control system 1106 may be configured to selectively control powering a first section of the plurality of sections of the variable tint glazing at a first operating frequency OF1 1104, and powering a further section of the plurality of sections of the variable tint glazing at a further operating frequency OF2 1104. This may be, for example, to cause different sections of the VT glazing to have different tint levels (e.g. one darker and one lighter). The control system 1106 may be configured to compare the radio reception frequency 1102 with the first and further operating frequencies OF1 and OF2 1104, determine a first frequency shift for the first operating frequency OF1 1104 in dependence on the comparison, and determine a further frequency shift for the further operating frequency OF2 1104 in dependence on the comparison. The control system 1106 may be configured to then output a first frequency shift signal FS1 1108 indicative of the first determined frequency shift for controlling the operating frequency OF1 1104 of the first section of the variable tint glazing system 1110 and output a further frequency shift signal FS2 1108 indicative of the further determined frequency shift for controlling the operating frequency OF2 1104 of the further section of the variable tint glazing system 1110. For example, a frequency shift of +5 MHz may be applied to the operating frequency OF1 1104 of the first section, while a frequency shift of −5 MHz may be applied to the operating frequency OF2 1104 of the first section, to reduce interference between the respective operating frequencies and the RRF of the radio receiver.

The control system 1106 may comprise input means arranged to receive the frequency band signal 1102 indicative of a radio reception frequency of a radio receiver of the vehicle; processing means 1120 arranged to compare the radio reception frequency with the operating frequency of the variable tint glazing system, and to determine the frequency shift 1108 for the operating frequency 1104 in dependence on the comparison; and output means arranged to output the frequency shift signal 1108 indicative of the determined frequency shift to control the operating frequency of the variable tint glazing system 1110.

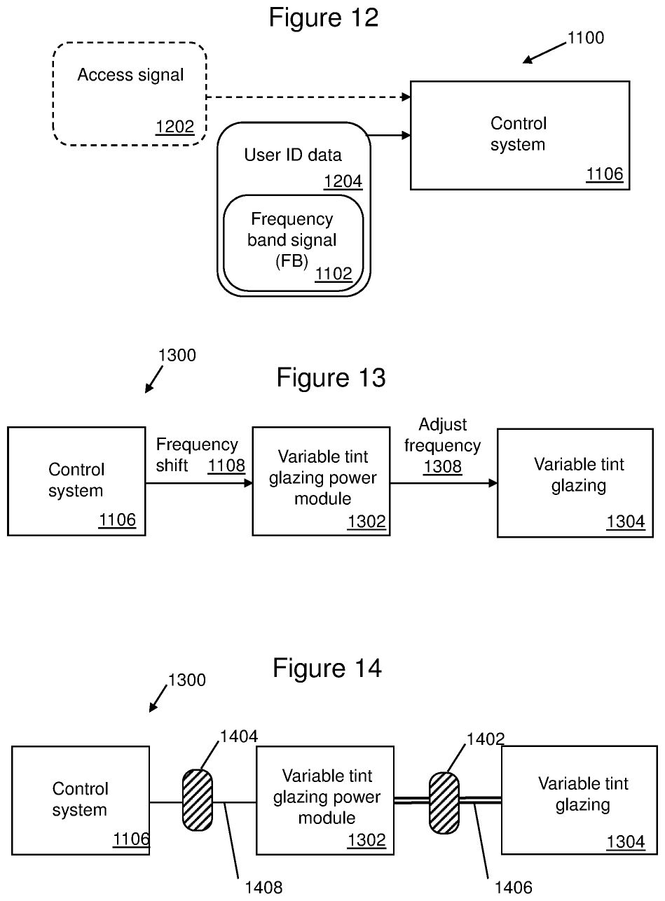

FIG. 12 shows provision of an access signal 1202 to a control system 1106. In this example, the control system 1106 is configured to receive the frequency band signal 1102 in dependence on receipt of user identification data 1204, wherein the user identification data 1204 is indicative of a particular user accessing the vehicle. This is discussed above in relation to FIG. 8. The user may, for example when approaching the vehicle, cause transmission of an access signal 1202 to the control system 1106 to indicate that they are likely to use the vehicle. That is, the control system 1106 may be configured to receive an access signal 1202 indicative of a likelihood of a user accessing the vehicle, and retrieve the user profile data in dependence on receipt of the access signal 1202.

Receipt of the access signal causes user ID data 1204 comprising the frequency band signal 1102 to be transmitted to the control system 1106. The control system 1106 may be configured to retrieve the user profile data associated with the user identification data, and the received frequency band signal may be associated with, or be a part of, the retrieved user profile data. The control system may be configured to retrieve the user profile data from a memory storage located in the vehicle, from a remote server or from the cloud, for example. The control system 1106 can then compare the radio reception frequency indicated by the frequency band signal 1102 with an operating frequency 1104 of the variable tint glazing system, and determine a frequency shift for the operating frequency 1104 in dependence on the comparison.

In this way, the VT glazing system may be controlled to set the VT glazing tinting both according to the user profile (for example in advance of the user occupying the vehicle so the tinting is set according to that user's preferences or settings ready for vehicle occupancy), and using an operating frequency (possibly frequency shifted) which is selected to reduce interference in the audio output from a radio of the vehicle which is tuned to a radio station also according to the user settings (e.g. the user's preselected radio station or last used radio station by that user). The control system is therefore configured to pre-emptively adapt the VT glazing of the vehicle and the radio audio output for a particular user ready for the user occupying the vehicle and in a way which reduces audio interference in the radio audio output due to operation of the VT glazing. This may enhance the user experience of using the vehicle.

FIG. 13 shows a VT glazing system 1300 of a vehicle. The VT glazing system 1300 comprises a control system 1106 as described herein, the VT glazing 1304 of the vehicle (e.g. the glass panels), and a VT glazing power module 1302 arranged to power the variable tint glazing 1304. The VT glazing power module 1302 in this example is arranged to receive the frequency shift signal 1108 output from the control system 1106 and adjust the operating frequency 1308 of the variable tint glazing power module 1302 in dependence on the frequency shift signal 1108. The VT glazing power module 1302 may power the VT glazing 1304, and may comprise a DC-AC converter arranged to provide AC power to the VT glazing 1304 at the (adjusted) operating frequency 1308.

The VT glazing of any examples disclosed herein may comprise one or more of: electrochromic glazing, suspended-particle glazing, micro-blind glazing, polymer-dispersed liquid crystal glazing, thermochromic glazing, and photochromic glazing.

Electrochromic glazing, which may be called smart glass or dynamic glass in some contexts, comprises powered glass panels, wherein the tint of the glass is electrically controlled. For example, increasing the voltage applied to the electrochromic glazing may darken the tint, and decreasing the voltage applied to the electrochromic glazing may lighten/remove the tint.

Suspended-particle glazing may comprise a glazing panel with a layer of suspended particles such as nano-rods. Applying a voltage controls the tinting of the glazing. When no voltage is applied, the suspended particles may be randomly organized, thus blocking and absorbing light. When voltage is applied, the suspended particles may align and let light pass through, and different voltages may vary the tint of the glazing (for example a higher voltage results in a darker tint).

Micro-blind glazing may use an applied voltage to control the amount of light passing through the glazing. Micro-blinds may be composed, for example, of very small metal blinds/louvres on or in at least partially conductive glass. If no voltage is applied, the micro-blinds may be rolled up and light can pass through the glazing, but applying a voltage may cause an electric field to form and cause the rolled micro-blinds to stretch out and thus block light. Varying the voltage may control the extent to which the micro-blinds stretch out and thus the tint of the glazing.

Polymer-dispersed liquid crystal glazing may be thought of as a mixture of polymer and liquid crystal which may be sandwiched between supporting glass or plastic. Applying a voltage across the glazing may cause the liquid crystal droplets to align and allow light to pass through the glazing, whereas with no applied voltage, the droplets may be randomly aligned, causing the glazing to have a translucent tint and disperse light passing through the glazing. Varying the voltage may allow for the level of translucency (tint) to be controlled.

Photochromic glazing may refer to glazing or to a self-adhesive film applied to glazing (which itself may comprise powered VT glazing) and the photochromic glazing itself may not need electrical power. It may thus be considered to be a “passive” glazing element, which may be used in combination with “active” glazing which is powered. Photochromic glazing changes tint when exposed to solar radiation, becoming darker on exposure and returning to a higher transparency when no longer exposed to the light.

Thermochromic glazing may be considered to be a “passive” glazing element, which may be used in combination with “active” glazing which is powered, similarly to photochromic glazing. Thermochromic glazing changes tint when exposed to heat such as the heat provided by solar radiation, becoming darker on heating and returning to a higher transparency when cooled.

FIG. 14 shows a VT glazing system 1300 of a vehicle comprising a ferrite 1402, 1404 (a ferrite may be considered to be a device which fits around a cable or wire, and acts to reduce the level of electromagnetic (EM) interference produced by the cable/wire by preventing it from acting as an antenna). In other examples, there may be only one of the illustrated ferrites 1402, 1404, or there may be more than one ferrite at the illustrated locations.

The variable tint glazing system may comprise a high voltage, HV, wire 1406 connected between the variable tint glazing power module 1302 and the variable tint glazing 1304, and a ferrite 1402 located on the HV wire. The variable tint glazing system may comprise a low voltage, LV, wire 1408 connected between the variable tint glazing power module 1404 and a power supply of the vehicle (for example, the power supply may be a body domain module, body control module, body power module), and a ferrite 1404 located on the LV wire 1408. The LV wire 1408 may be a wiring harness. In some examples, there may be metallic shielding in place to reduce the levels of EM interference in the cabling/system. In some examples, the LV wire/harness may be triple-twisted to reduce the levels of EM interference in the cabling/system.

Because the disclosed systems acting to reduce EM interference do not require a transformer, the resulting system may be manufactured to be relatively small and light, such that it may in some examples weigh around 100 g. Such a small and light system may be packaged at many different places within the vehicle, such as by directly fixing it on the body in white, e.g. with a suitable ground point on the vehicle chassis. The disclosed systems may also be considered to be power efficient. Some examples may produce an output voltage of around 100V, but produce a required power level which is relatively low, e.g. around the same level required to charge a smartphone.

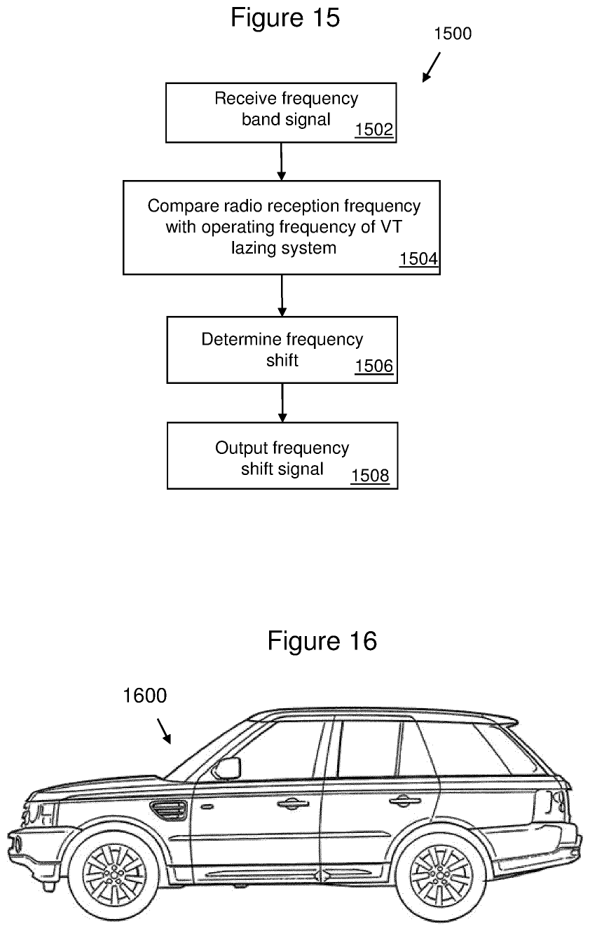

FIG. 15 illustrates a method 1500 of controlling a variable tint glazing of a vehicle. The method 1500 comprises: receiving a frequency band signal 1502 indicative of a radio reception frequency of a radio receiver of the vehicle; comparing the radio reception frequency with an operating frequency of the variable tint glazing system 1504; determining a frequency shift for the operating frequency 1506 in dependence on the comparison; and outputting a frequency shift signal indicative of the determined frequency shift 1508 for controlling the operating frequency of the variable tint glazing system.

The method 1500 may comprise, in some examples, during audio output provided by an audio output system of the vehicle (the audio output provided in dependence on radio signals received at the radio reception frequency of the radio receiver of the vehicle), applying the frequency shift to the operating frequency to shift the operating frequency to be outside the radio reception frequency.

The method 1500 may comprise, in some examples, determining the frequency shift by calculating, in dependence on the operating frequency of the variable tint glazing system and the radio reception frequency, the frequency shift. The method 1500 may comprise, in some examples, determining the frequency shift by retrieving the frequency shift from a look up table, wherein the frequency shift is predetermined to correspond to the radio reception frequency.

FIG. 16 illustrates a vehicle 1600, such as the vehicle described in relation to the examples of FIGS. 1 to 15. The vehicle 1600 is a wheeled vehicle. The vehicle 1600 may comprise any control system, VT glazing system or VT glazing described above. In some embodiments the vehicle 1600 may be arranged to perform a method according to an example described herein, such as those illustrated in FIG. 10 or FIG. 15.

As a further aspect, there is provided computer software which, when executed by a processor, is arranged to cause the processor to perform any method disclosed herein. The computer software may be stored on a computer-readable medium. The computer software may be stored on a non-transient computer-readable medium, such as a memory 211 as shown in FIG. 2. The computer software may be called instructions or computer-readable instructions.

It will also be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a computer program comprising code for implementing a system or method as claimed, and a machine-readable storage storing such a program (e.g. a non-transitory computer readable medium). Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A control system for a variable tint glazing for a vehicle, the control system comprising one or more controllers, the control system being configured to:
receive an access signal comprising user identification data, the access signal being indicative of a likelihood of a user accessing the vehicle; and
retrieve user profile data associated with the user identification data, the user profile data being indicative of a tinting configuration of at least a portion of the variable tint glazing; and
output a tint control signal to control the at least a portion of the variable tint glazing to adopt the tinting configuration thereof.

2. The control system of claim 1, wherein:
the variable tint glazing comprises a plurality of sections; and
the user profile data is indicative of a first tinting configuration for a first section of the variable tint glazing and a second tinting configuration for a second section of the variable tint glazing.

3. The control system of claim 1, wherein a radio reception frequency of a radio receiver of the vehicle is stored, and wherein the tinting configuration comprises an operating frequency of the variable tint glazing which is different to the stored radio reception frequency.

4. The control system of claim 1, wherein the control system is further configured to:
receive a power-on signal based at least in part on a power level of the vehicle being set, wherein the power level is indicative of the vehicle being in a ready-to-move state; and
output the tint control signal based at least in part on receipt of the power-on signal.

5. The control system of claim 1, wherein the control system is further configured to:
receive a vacate signal indicative of a user no longer occupying the vehicle;
generate a power-off signal arranged to cause the variable tint glazing to be in a dark state based at least in part on the vacate signal; and
output the power-off signal to the variable tint glazing.

6. The control system of claim 1, comprising:
input means arranged to receive the access signal comprising user identification data;
processing means arranged to retrieve the user profile data associated with the user identification data based at least in part on the access signal; and
output means arranged to output the tint control signal indicative of the tinting configuration to control the variable tint glazing based at least in part on the user profile data.

7. A variable tint glazing system for a vehicle, the variable tint glazing system comprising:
the control system of claim 1; and
the variable tint glazing of the vehicle, wherein the variable tint glazing of the vehicle is arranged to receive the tint control signal outputted from the control system and adjust a tint level of the variable tint glazing based at least in part on the tint control signal.

8. The variable tint glazing system of claim 7, wherein:
the variable tint glazing comprises a plurality of sections of variable tint glazing;
the tint control signal comprises a plurality of section tint control signals corresponding to the plurality of sections of variable tint glazing;
a first section of the plurality of sections is arranged to receive a first section tint control signal and provide a first adjusted tint level based at least in part on the first section tint control signal; and
a further section of the plurality of sections is arranged to receive a further section tint control signal and provide a further adjusted tint level based at least in part on the further section tint control signal.

9. A distributed system for controlling a variable tint glazing of a vehicle, the distributed system comprising:
the variable tint glazing system of claim 7; and
at least one access device arranged to transmit the access signal to the control system.

10. The distributed system of claim 9, wherein the control system is configured to receive the access signal based at least in part on the at least one access device being located within a predetermined distance from the vehicle.

11. The distributed system of claim 9, wherein the control system is configured to receive the access signal based at least in part on receipt of an unlock signal to unlock the vehicle.

12. A vehicle comprising the control system of claim 1.

13. A method of controlling a variable tint glazing of a vehicle, the method comprising:
receiving an access signal comprising user identification data, the access signal indicative of a likelihood of a user accessing the vehicle;
retrieving user profile data associated with the user identification data, the user profile data indicative of a tinting configuration of at least a portion of the variable tint glazing; and
outputting a tint control signal indicative of the tinting configuration for controlling the variable tint glazing based thereon.

14. The method of claim 13, wherein the method comprises one or more of the following:
determining that an access device is located within a predetermined distance from the vehicle, and receiving the access signal from the access device based at least in part on the determination;
determining that the access device is located within the predetermined distance from the vehicle and moving towards the vehicle, and receiving the access signal from the access device based at least in part on the determination;
receiving an unlock signal to unlock the vehicle, and receiving the access signal based at least in part on receiving the unlock signal; and
receiving a manual signal transmitted intentionally by the user as an indication that the user wishes to set a tint level of the variable tint glazing.

15. Computer software which, when executed by a processor, is arranged to cause the processor to perform the method according to claim 13.

16. The control system of claim 3, wherein the control system is configured to:
compare the radio reception frequency with the operating frequency of the variable tint glazing;
determine a frequency shift for the operating frequency based on the comparing; and
output a frequency shift signal indicative of the determined frequency shift for controlling the operating frequency of the variable tint glazing.

17. The distributed system of claim 10, wherein the control system is configured to receive the access signal based on the at least one access device being determined to be moving towards the vehicle.

18. The computer software according to claim 15, wherein the computer software is stored on a computer-readable medium.
